(19) United States
(12) Patent Application Publication
(10) Pub. No.: US 2012/0147486 A1
(43) Pub. Date: Jun. 14, 2012

(54) TABLE TENT READER

(76) Inventors: Kevin Narans, Evergreen, CO (US); Darren Narans, Evergreen, CO (US)

(21) Appl. No.: 13/326,282

(22) Filed: Dec. 14, 2011

Related U.S. Application Data
(60) Provisional application No. 61/422,910, filed on Dec. 14, 2010.

(51) Int. Cl. G02B 27/02

(52) U.S. Cl. 359/802

(57) ABSTRACT

The table tent reader according to the present invention comprises a table tent print holder which has gap for receiving printed materials; and a magnifying strip connected to the top edge of the table tent print holder. The table tent print holder in general functions like a table tent for receiving and display the printed materials. In addition, the table tent print holder has a unique feature; it has a slot (an additional integrated connection groove or an open space above the space for receiving the printed material) for holding the magnifying strip which can help users to read the printed materials especially those with fine prints without the need for a reading glasses. The strip magnifies reading and can be molded into the table tent print holder or may be removably attached to the table tent print holder.

### REFERENCE TO RELATED APPLICATIONS

This patent application claims the benefit of U.S. Provisional Application No. 61/422,910 filed on Dec. 14, 2010, the disclosure of which is incorporated herein by reference in its entirety.

### BACKGROUND OF THE INVENTION

1. Field of the Invention

The present invention relates to a reading utensil, and more particularly to a reading utensil as part of a typical table tent for helping customers to read the printed materials.

2. Description of Related Art

There is a long-felt need for a solution to the problem of not being able to read the small print including but not limited to from restaurant and bar menus and table bills when customers do not have reading glasses with them.

U.S. Pat. No. 4,030,814 to Clifton et al. discloses a device for holding, viewing recipes and the like written on cards or other data storing means has a hollow triangular frame, a holder in the front of the frame, a magnifying glass, a stand for holding the data while it is viewed and light means in the frame between the magnifying glass and the stand. The device is cumbersome and complex. Considering the fact that the device has gotten patented for a long time whereas it is not commercialized, it may be due to its shortcomings which is cumbersome and complex and is not suitable to be used in a restaurant or bar or entertainment establishments. The long-felt need still exists suggests that a need for a simple version of reading aids still exists.

U.S. Pat. No. 6,764,192 to McChesney discloses a combination magnifier and illuminator comprised of a rigid rectangular housing that encloses a swing out lens retaining frame. The devices described include magnifying means but do not comprise holding, storing for the magnifying lens.

U.S. PreGrant publication 2004/0156125 to Graham et al. discloses a magnifying document holder including a book-like holder in which a magnifying lens is attached by a hinge. The usage of the device is limited; the device is designed for reading a book-like printed materials.

U.S. Pat. No. 6,249,390 discloses a magnifying insert designed particularly for a binder having separable binding members for securing pages of printed material therein includes a substantially rectangular panel which is a Fresnel lens for magnifying small or unreadable indicia on the pages secured within the binder. As mentioned, the device is designed particularly for a binder.

U.S. Pat. No. 3,209,648 to Chapman discloses a novel book mark including magnifying means adapting the book mark particularly for use with a telephone directory or the like. The devices described include magnifying means but do not comprise holding, storing for the magnifying lens.

U.S. Pat. No. 3,212,794 to Crossan discloses a note-pad mount which includes magnifying means as an integral part thereof. The devices described include magnifying means but do not comprise holding, storing for the magnifying lens.

There is a long-felt need for a solution to the problem of not being able to read the printed materials (in small print) in table tents displayed in a restaurant, a bar, a hotel room, lobby, and/or conference/meeting settings when customers do not have reading glasses with them. These printed materials displayed in table tents include but is not limited to restaurant and bar menus and hotel instructions, etc. There are no products commercially available and convenient in entertainment or business establishments that provide immediate reading aids in proximity to the printed materials for helping customers to read the printed materials.

The device of the present invention solves the problem of not being able to read the small print when customers do not have reading glasses with them.

### SUMMARY OF THE INVENTION

It is one object of the present invention to provide a magnifying strip along the top portion of a table tent that allows the patron to read the printed materials including but not limited to menus and check bills without the need for a reading glasses. The strip magnifies reading and can be molded into the table tent or may be removably attached to the table tent.

Any patron at a restaurant, nightclub, bar, hotel room, lobbies, conference/meeting settings or anywhere else a table tent marketing piece may be present can benefit from the table tent reader according to the present invention.

The table tent reader according to the present invention comprises a table tent print holder which has gap for receiving printed materials; and a magnifying strip connected to the top edge of the table tent print holder. The table tent print holder in general functions like a table tent for receiving and display the printed materials. In addition, the table tent print holder has a unique feature; it has a slot (an additional integrated connection groove or an open space above the space for receiving the printed material) for holding the magnifying strip which can help users to read the printed materials especially those with fine prints without the need for a reading glasses.

The magnifying strip can be molded into the table tent print holder as one unit or may be removably connected to the table tent print holder. When the magnifying strip is designed to be removably connected, the magnifying strip has a projection designed to match with and for inserting into the slot on the top edge portion of the table tent print holder. The magnifying strip may contain Fresnel lenses which can be stamped and/or molded of transparent plastic and/or acrylic and/or Fresnel glass lens. The table tent print holder may be made from molded plastic and/or acrylic and/or wood and/or wire metal.

The table tent reader of the present invention can be used with the magnifying strip locked in place on top of the table tent reader or can be easily removed and then held over whatever the user wants to magnify for the purpose of being able to read smaller print items. The magnifying strips could also be imprinted for marketing and could be taken home by the user as a token of appreciation from the giving establishment.

The more important features of the invention have thus been outlined in order that the more detailed description that follows may be better understood and in order that the present contribution to the art may better be appreciated. Additional features of the invention will be described hereinafter and will form the subject matter of the claims that follow.

Before explaining at least one embodiment of the invention in detail, it is to be understood that the invention is not limited in its application to the details of construction and the arrangements of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

The foregoing has outlined, rather broadly, the preferred feature of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention and that such other structures do not depart from the spirit and scope of the invention in its broadest form.

### BRIEF DESCRIPTION OF THE DRAWINGS

Other aspects, features, and advantages of the present invention will become more fully apparent from the following detailed description, the appended claim, and the accompanying drawings in which similar elements are given similar reference numerals.

FIG. 1 is a front isometric view of a table tent reader 1 according to one embodiment of the present invention showing the table tent print holder 10 incorporated with a Magnifying Strip 20.

FIG. 2 is a rear isometric view of the table tent reader 1 disclosed in FIG. 1.

FIG. 3 is a side elevation view of the table tent reader 1 disclosed in FIG. 1 which is enlarged to show the gap 15 for receiving the printed materials and connection groove 16 along the top edge 11 of the print holder 10 for receiving the magnifying strip 20.

FIG. 4 is a front isometric view of one of the magnifying strips 20 showing the attachment edge 22 and the projection 24 for inserting into the connection groove 16 of the table tent print holder 10.

FIGS. 5A, 5B, 5C, 5D are a side views of the magnifying strips 20 and their projections 24 to be inserted into the connection groove 16 of the table tent print holder 10.

FIG. 6A, 6B, 6C are side elevation views thereof enlarged to show various shapes of connection groove 16 for receiving the magnifying reader strip 20.

FIG. 7 is a front isometric view of a table tent reader 1 according to another embodiment of the present invention showing the table tent print holder 10 incorporated with a Magnifying Strip 20.

FIG. 8 is a side elevation view of the table tent reader 1 disclosed in FIG. 7 which is enlarged to show the gap 15 for receiving the printed materials and the magnifying strip 20 with projection 24. The projection 24 can fit in the gap 15 and the depth of the magnifying reader strip 20 is larger than the depth of the gap 15 so that the magnifying reader strip 20 is held in place on top of the print holder 10.

FIG. 9 is a front isometric view of one of the magnifying strips 20 showing a nose cutout 26.

### DESCRIPTION OF THE PREFERRED EMBODIMENT

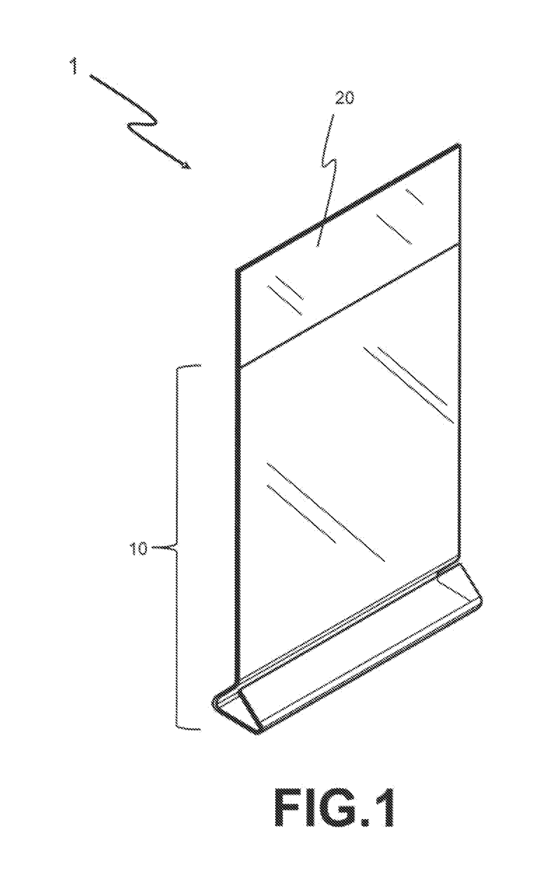

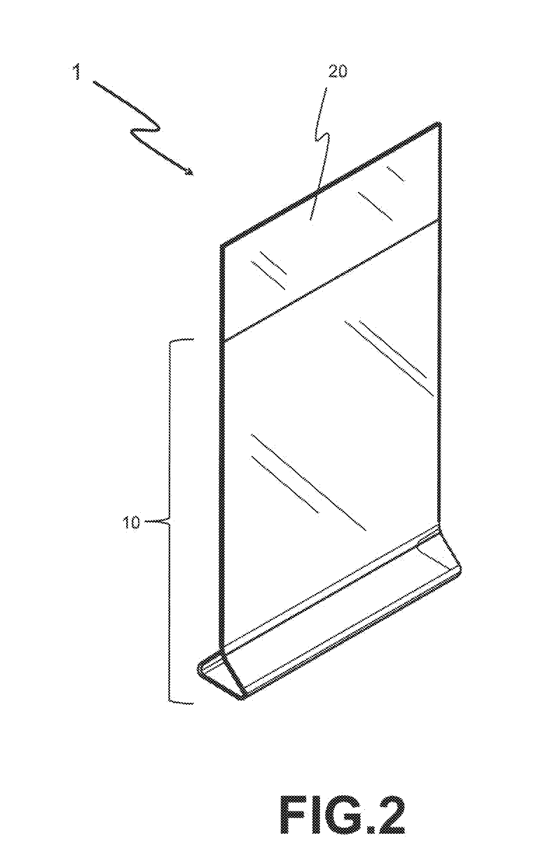

Referring to FIGS. 1-3, there is disclosed a front view, a rear view and a side view of a Table Tent Reader according to the present invention. Table tent reader 1 of the present invention comprises a table tent print holder 10 and a magnifying strip 20 which is removably connected to the table tent print holder 10. The table tent print holder 10 may comprise one molded transparent plastic piece and/or acrylic piece which extends downward to form a first generally planar upright portion 13 and turns to form a triangular shaped base 17 and then turns again and extends upward to form a second generally planar upright portion 14 which is parallel with and separate from the first generally planar portion 13, thus creates a slot/gap 15 in between the two portions 13 and 14 where the printed materials can be inserted and displayed. Each of the two generally planar upright portions 13 and 14 has a top edge 11, and four side edges.

Alternatively, the table tent print holder 10 may comprise two transparent plastic pieces; each comprises a generally planar upright portion 13, 14 having a top edge 11 and four side edges; said two pieces having the planar portions 13, 14 held in parallel and separate, whereas permanently unite together along portions of their bottom edges thus create a slot/gap 15 in between the two portions 13 and 14 where printed materials can be inserted. The table tent print holder 10 may be made of two transparent acrylic pieces instead of two transparent plastic pieces.

Said printed materials should be shorter than the table tent print holder 10 in order to reveal the magnifying strip 20 at the leading top edge 11. This magnifying strip 20 would be used to read the printed materials including but not limited to the restaurant menus, bar menus or anything in close proximity to the print holder 10.

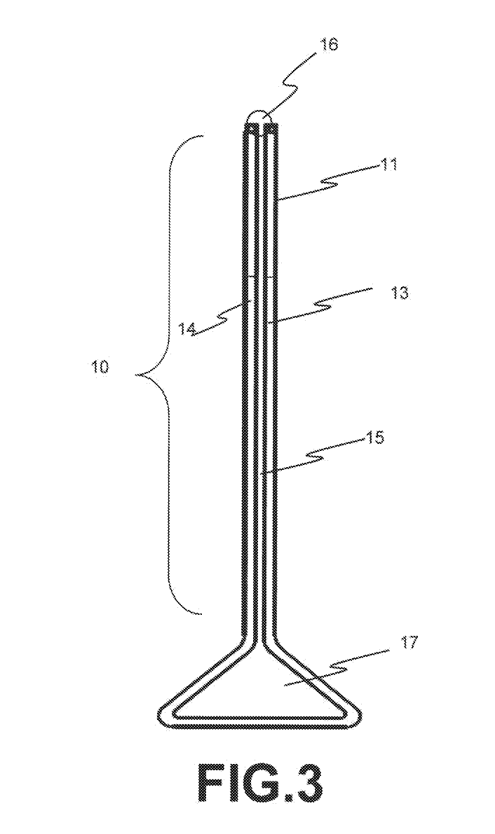

In order to hold magnifying strip 20 in place, the print holder 10 may have an integrated groove 16 on its top edge 11 for receiving the magnifying strip 20. Said integrated groove 16 can be observed in FIG. 3.

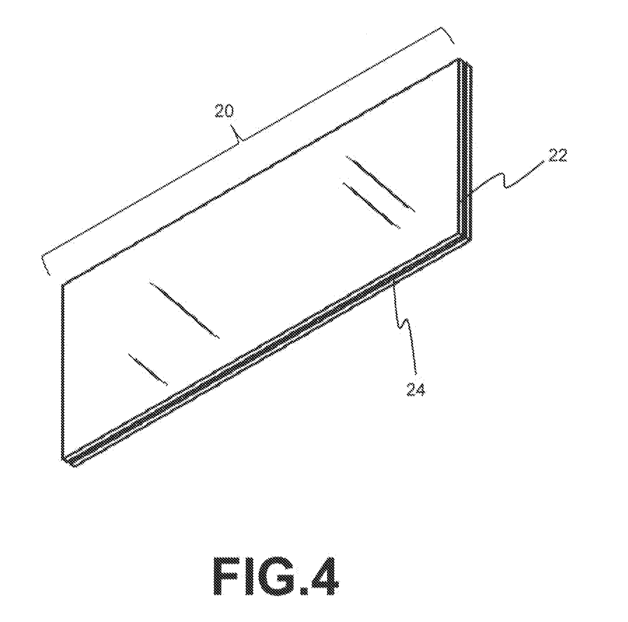

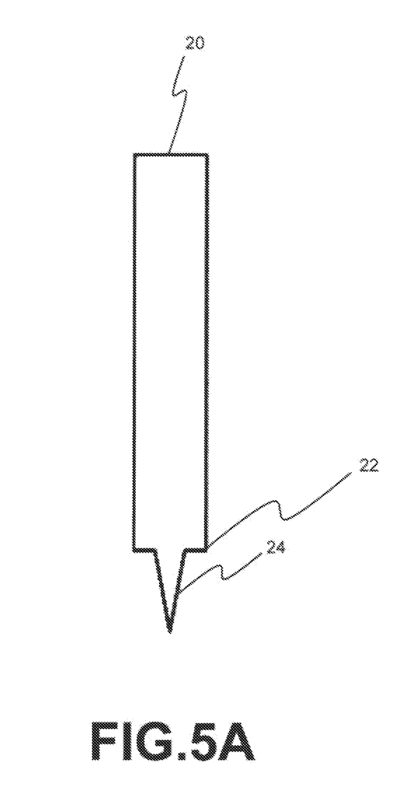

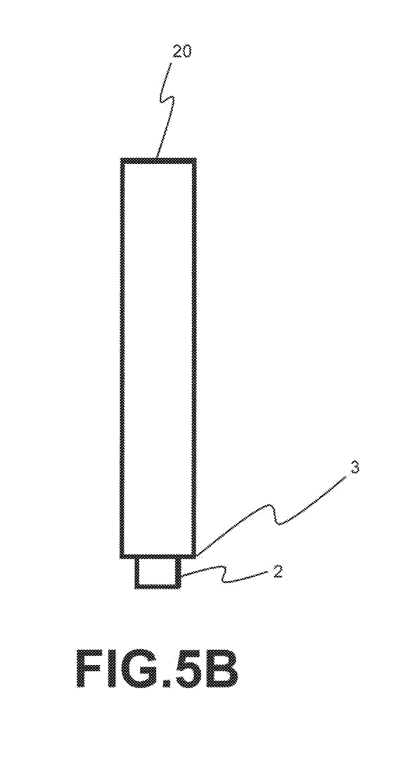

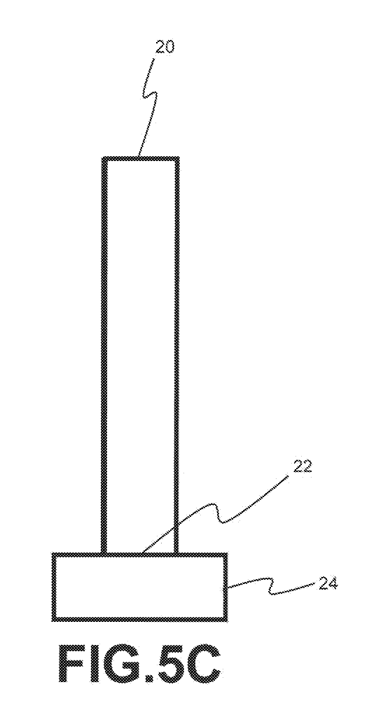

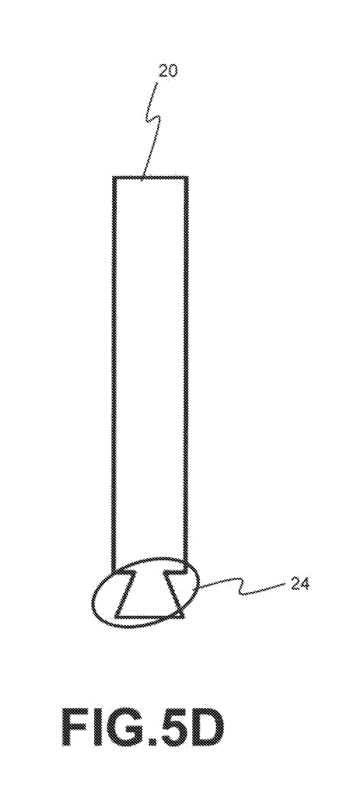

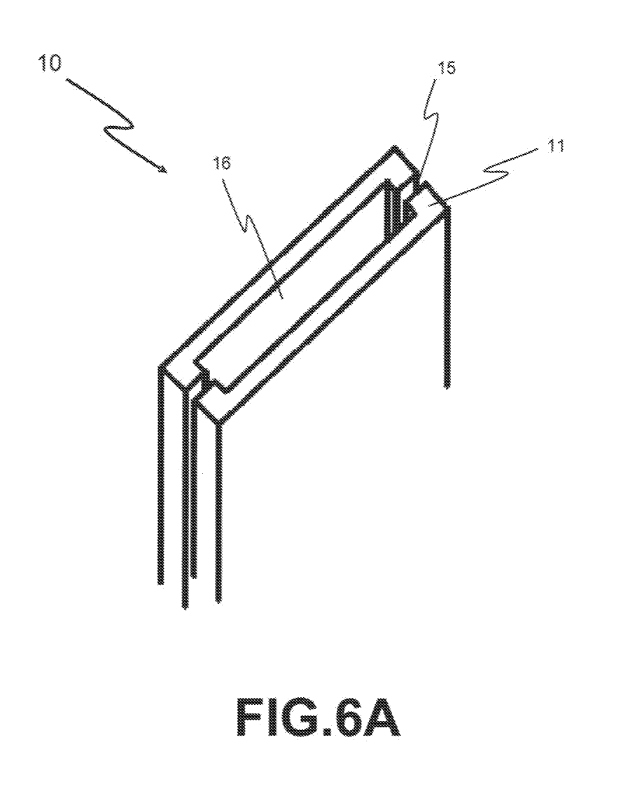

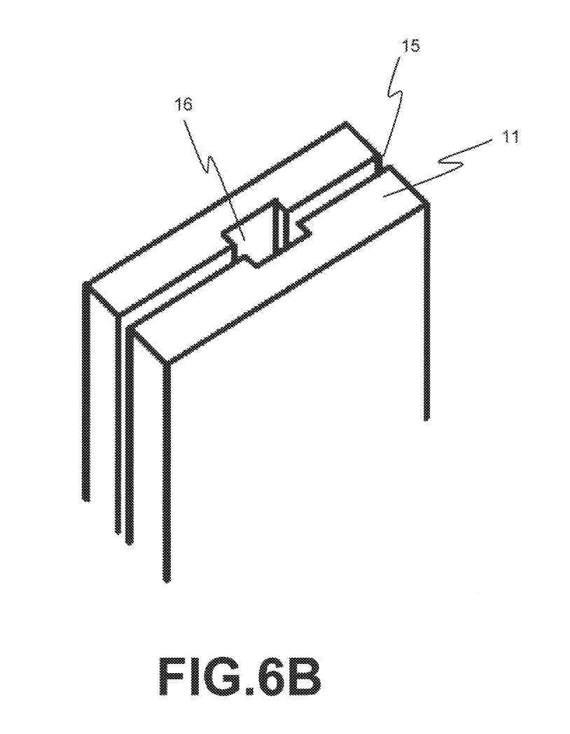

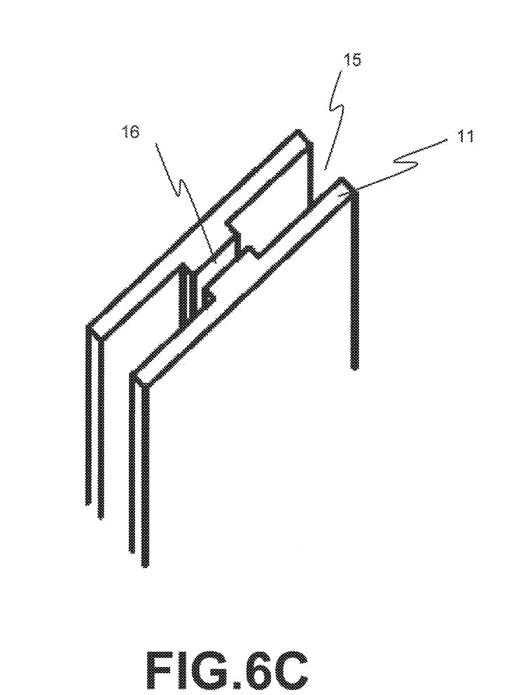

Now, referring to FIG. 4, there is disclosed a front view of a magnifying strip 20. On the bottom attachment edge 22, said magnifying strip 20 has a projection/protrusion 24 designed to match with and for inserting into the integrated groove 16 on the print holder 10 such that the magnifying strip 20 can be locked in place on top of the print holder 10 with the bottom attachment edge 22 in contact with the top edge 11 of the holder 10. The depth (denotes “16d1” in the figure) of the integrated groove 16 may be larger than the depth of gap 15 (denotes “15d2 in the figure) as shown in FIG. 6A, 6B or smaller than the depth of gap 15 (as shown in FIG. 6C). The magnifying strip 20 shall slide along the integrated groove 16 on the top edges 11 of the table tent print holder 10 and can be removed for more discreet viewing.

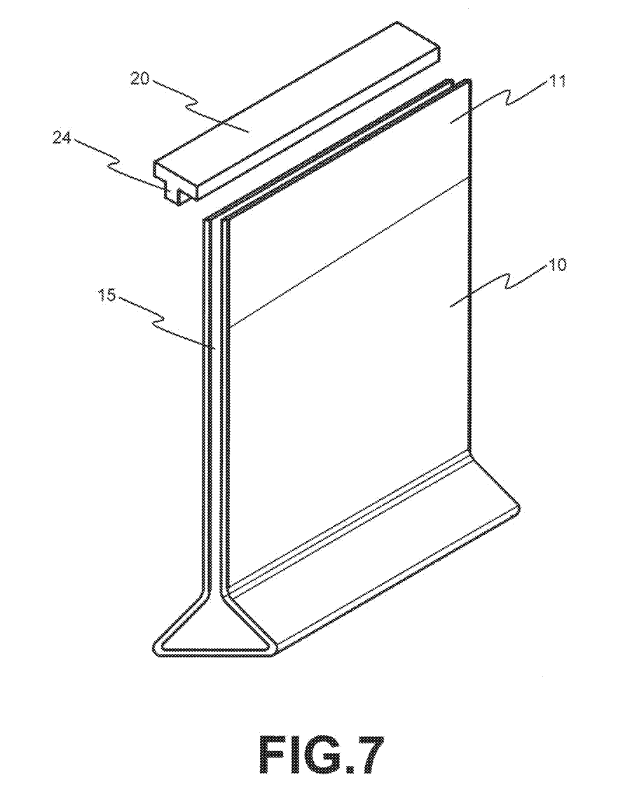

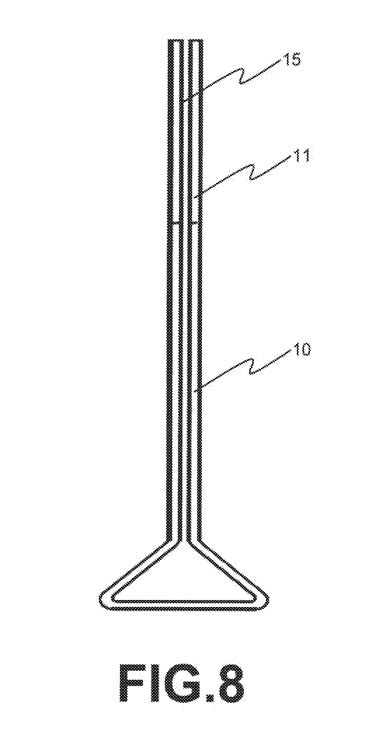

As shown in FIG. 7, the integrated groove 16 may not be necessary if the width of the magnifying strip 20 is larger than the depth of the gap 15 (15d1) along the top edge 11 and the projection 22 can fit into the gap 15 along the top edge 11 of the print holder 10. The magnifying strip 20 shall slide along the top edge of the gap 15 of the table tent print holder 10 and can be removed for more discreet viewing. The print holder 10 in this embodiment has shape different from the embodiment disclosed in FIG. 1. The two parallel generally planar portions 13 and 14 are tilted from the horizontal display plane.

The two generally planar portions 13 and 14 may be of various shapes including but not limited to a rectangular and oblong shape, preferably a rectangular shape. The base 17 may be of various shapes including but not limited to a rectangular, triangular and oblong shape.

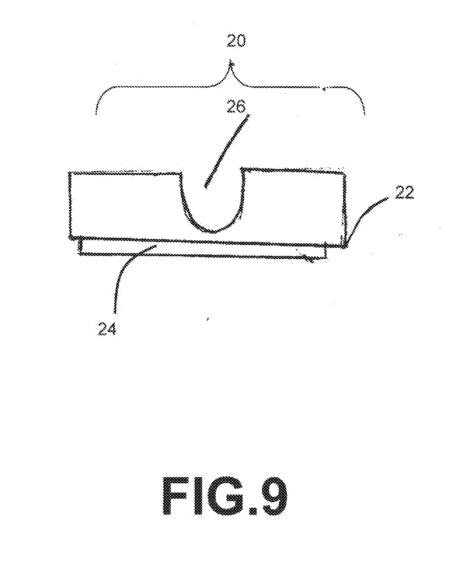

In an alternative embodiment, said magnifying strip 20 could also have a nose cut-out 26 in the center as shown in FIG. 9 for being able to be held closer to a user's eyes.

The table tent print holder 10 of the table tent reader 1 according to the present invention may take forms of many table tent that already exist for marketing purposes in most food, bar, hotel, conference/meeting establishments as well as numerous other entertainment or business facilities. The magnifying strip 20 may be molded into the table tent print holder 10 or removably attached to the table tent print holder 10. When the magnifying strip 20 is designed to be removably attached to the table tent print holder 10, the required and unique feature for the table tent print holder 10 of the present invention is that the print holder 10 would be manufactured with a slot/gap along the top edge so as to hold the magnifying strip 20. The magnifying strip 20 may contain Fresnel lenses which can be stamped or molded of transparent plastic and/or acrylic. Fresnel lenses are known to be flatter and thinner than conventional magnifying glasses. The magnifying strip 20 may also contain Fresnel glass lens. The print holder 10 may be made from molded plastic and/or acrylic and/or wood and/or metal wire.

The magnifying strip 20 will slide into the slot in the table tent print holder 10 to lock it in place when not in use or can be easily removed and then held over whatever the user wants to magnify for the purpose of being able to read smaller print items such as menus, table checks, etc. without the need for reading glasses. The strips 20 could also be imprinted for marketing and could be taken home by the user as a token of appreciation from the giving establishment.

While there have been shown and described and pointed out the fundamental novel features of the invention as applied to the preferred embodiments, it will be understood that the foregoing is considered as illustrative only of the principles of the invention and not intended to be exhaustive or to limit the invention to the precise forms disclosed. Obvious modifications or variations are possible in light of the above teachings. The embodiments discussed were chosen and described to provide the best illustration of the principles of the invention and its practical application to enable one of ordinary skill in the art to utilize the invention in various embodiments and with various modifications as are suited to the particular use contemplated All such modifications and variations are within the scope of the invention as determined by the appended claims when interpreted in accordance with the breadth to which they are entitled.

What is claimed is:

1. A table tent reader comprises a table tent print holder which has a gap for receiving and displaying printed materials; and a magnifying strip connected to the table tent print holder.

2. The table tent reader of claim 1, wherein the magnifying strip can be molded into the table tent print holder or may be removably connected to the table tent print holder.

3. The table tent reader of claim 1, wherein the table tent print holder further has an integrated connection groove along its top edge for receiving the magnifying strip.

4. The table tent reader of claim 1, wherein the magnifying strip has a projection extending from its bottom, the projection is designed to match with and for inserting into the gap at its top edge.

5. The table tent reader of claim 2, wherein the magnifying strip has a projection extending from its bottom, the projection is designed to match and for inserting into the integrated connection groove.

6. The table tent reader of claim 1, wherein the magnifying strip may contain Fresnel lenses which can be stamped or molded of transparent plastic or acrylic.

7. The table tent reader of claim 1, wherein the magnifying strip may contain Fresnel glass lens.

8. The table tent reader of claim 1, wherein the table tent print holder is made from molded plastic or acrylic.

9. The table tent reader of claim 1, wherein the table tent print holder is made from wood or wire metal.

10. The table tent reader of claim 1, wherein he magnifying strip has a nose cut-out for being able to

11. The table tent reader of claim 1, wherein the table tent print holder comprises one molded transparent plastic piece which extends downward to form a first generally planar portion and turns to form a triangular shaped base and turns again and extends upward to form a second generally planar portion which is parallel with and separate from the first generally planar portion, thus creating a gap where the printed materials can be inserted; each of the two generally planar upright portions has a top edge and four side edges.

12. The table tent reader of claim 11, wherein the two generally planar portions may be upright or angled from the horizontal table plane.

13. The table tent reader of claim 11, wherein the two generally planar portions may be of various shapes including but not limited to a rectangular and oblong shape, preferably a rectangular shape.

14. The table tent reader of claim 1, wherein the table tent print holder comprises two transparent plastic pieces, each piece comprises a generally planar portion having a top edge and four side edges; said two pieces having the two planar portions arranged in parallel and held separate from each other but permanently united together along portions of their bottom edges thus creating a gap where printed materials can be inserted.

15. The table tent reader of claim 14, wherein the two generally planar portions may be upright or angled from the horizontal table plane.

16. The table tent reader of claim 14, wherein the two generally planar portions may be of various shapes including but not limited to a rectangular and oblong shape, preferably a rectangular shape.

17. A table tent reader comprises a table tent print holder which has a gap for receiving and displaying printed materials; and a magnifying strip connected to the table tent print holder, wherein the magnifying strip is removably attached to the table tent print holder, the table tent print holder comprises one molded transparent plastic piece which extends downward to form a first generally planar portion and turns to form a triangular shaped base and turns again and extends upward to form a second generally planar portion which is parallel with and separate from the first generally planar portion, thus creating a gap where the printed materials can be inserted, each of the two generally planar upright portions has a top edge and four side edges to define the top edge of the table tent print holder which has an integrated connection groove for receiving a projection on the magnifying strip, the magnifying strip contains Fresnel lenses which can be molded of transparent plastic or acrylic, the table tent print holder is made from molded plastic or acrylic.

18. A table tent reader comprises a table tent print holder which has a gap for receiving and displaying printed materials; and a magnifying strip connected to the table tent print holder, wherein the magnifying strip is molded into the table tent print holder, the magnifying strip contains Fresnel lenses which can be molded of transparent plastic or acrylic, the table tent print holder is made from molded plastic or acrylic.

19. The table tent reader of claim 1, wherein the magnifying strip has a nose cut-out for being able to be held closer to a user's eyes.

20. The table tent reader of claim 1, wherein the magnifying strips could also be imprinted for marketing advertisement.
